(19) United States
(12) Patent Application Publication
(10) Pub. No.: US 2009/0136096 A1
(43) Pub. Date: May 28, 2009

(54) SYSTEMS, METHODS AND APPARATUS FOR SEGMENTATION OF DATA INVOLVING A HIERARCHICAL MESH

(75) Inventors: Saad Ahmed Sirohey, Pewaukee, WI (US); Rakesh Mohan Lal, Plano, TX (US); Gopal B. Avinash, New Berlin, WI (US)

Correspondence Address: DEAN D. SMALL;THE SMALL PATENT LAW GROUP LLP, 225 S. MERAMEC, STE. 725T, ST. LOUIS, MO, 63105, US

(73) Assignee: GENERAL ELECTRIC COMPANY, Schenectady, NY (US)

(21) Appl. No.: 11/944,604

(22) Filed: Nov. 23, 2007

(51) Int. Cl. G06K 9/00

(52) U.S. Cl. 382/128

(57) ABSTRACT

Systems, methods and apparatus are provided through which in some embodiments, user interactions of adding, removing and selecting scale, within a mesh framework to improve repeatability and reproducibility of an arbitrary process in a three-dimensional medical space. In some embodiments, a multiple-mesh framework further improves performance of an arbitrary segmentation process.

### FIELD

This invention relates generally to medical diagnosis, and more particularly to analysis of healthcare images of a patient.

### BACKGROUND

Most clinical decisions are derived from an analysis of a critical set or sets of interest from some data source or sources. In the radiology domain, this typically involves the analysis of regions of interest from medical image data. Medical image analysis is performed at the request of a referring physician for a specific purpose; this purpose can range from the detection, assessment, progression of anatomical abnormalities like lesions, aneurysms, atrophies etc. In order to access these regions of interest and perform the necessary analysis, these regions must first be accurately and robustly separated from other non-essential data.

While many context specific algorithms, whose purpose is to segment regions of interest such as organs or other anatomical features or pathological structures such as lesion and nodules do exist, due to the variability in virtually all sources of medical data, these algorithms can never be perfect. Moreover, factors such as scale, noise, motion, partial voluming and other artifacts hamper the accuracy and precision of virtually every segmentation algorithm. In many practical applications, the main issue with results obtained from a segmentation algorithm is not whether or not the results are accurate based on a numerical criterion, but rather how a human user who is the final arbitrator in this matter perceives the results.

Imperfect segmentations are generally dealt with in a variety of manners. In some cases, the user will ignore the imperfection. In some other cases, the user will try to use some tools to manually adjust the segmentation. In yet other cases, users can resort to using a totally manual method of segmenting the regions of interest. All methods that involve manual adjustments including those that allow for adjustments to contours in two dimensions and three dimensions create a situation where the results of the manual segmentations cannot be reproduced with any degree of fidelity, for example in clinical studies there is an inter and an intra variability of 10% amongst radiologists determining the diameter of a lesion and in a volumetric sense that would translate to greater than 20% variability.

### BRIEF DESCRIPTION

In one aspect, a method includes accessing multi-dimensional data, partitioning the multi-dimensional data to form a hierarchical mesh with a plurality of segmentation elements at a plurality of scales, providing an interactive graphical user interface that is operable to passively select, add, remove and divide specific segmentation elements of the hierarchical mesh at any of the plurality of scales in response to commands from a human user, and presenting results of the commands on the interactive graphical user interface.

In another aspect, a process or group of processes generates a hierarchical mesh or set of hierarchical meshes. Once the hierarchical mesh is generated, the user can then interact with the data and select, add and remove individual mesh elements. Users can interact with the mesh elements at different levels in the hierarchy by manually selecting the desired scale, or through some automated method that selects the scale based on some pre-defined criteria. Additionally, the user can also select mesh elements from different meshes by selecting the mesh type. In this case, the user can interact with a new mesh while utilizing the result from a previous mesh. Once the user is satisfied with the segmentation, the final step involves displaying, storing or analyzing the results of the segmentation.

In yet another aspect, systems, methods and apparatus are operable to access multi-dimensional data, create multiple hierarchical partitioning of data into segmentation elements at multiple scales; provide user an interactive user interface to select, add, remove, divide etc. segmentation elements of the multiple hierarchical partitioning at a given scale, visualize interactively the results of user interaction, and store the results of the segmentation in a format suitable for recall/reproduction.

Systems, clients, servers, methods, and computer-readable media of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a block diagram of an overview of a system to visualize healthcare diagnostic images, according to an embodiment;

FIG. 2 is a flowchart of a method visualize healthcare image, according to an embodiment;

FIG. 3 is a flowchart of a method to partition multi-dimensional data to form a hierarchical mesh, according to an embodiment;

FIG. 4 is a flowchart of a method to generate a partitioned representation of all of the multi-dimensional data, according to an embodiment;

FIG. 5 is a flowchart of a method to generate a hierarchical mesh of all of the partitioned data, according to an embodiment;

FIG. 6 is a diagram of a hierarchy of segmentation elements, according to an embodiment;

FIG. 7 is a schematic diagram of a hierarchical segmentation of a cube using a basic partitioning approach, according to an embodiment;

FIG. 8 is a diagram of threshold bins to partition the data based on intensity, according to an embodiment;

FIG. 9 is an illustration of a multi-scale three-dimensional partitioned cubed region in a CT volume, according to an embodiment;

FIG. 10 is a simplified diagram of an overview of a modified system configured to improve X-ray imaging operations; and

FIG. 11 is a block diagram of a hardware and operating environment useful in the context of the environment of FIG. 10, according to an embodiment.

### DETAILED DESCRIPTION

In the following detailed description, reference is made to the accompanying drawings that form a part hereof, and in which is shown by way of illustration specific embodiments which can be practiced. These embodiments are described in sufficient detail to enable those skilled in the art to practice the embodiments. Other embodiments can be utilized and logical, mechanical, electrical and other changes can be made without departing from the scope of the embodiments. The following detailed description is, therefore, not to be taken in a limiting sense.

The detailed description is divided into five sections. In the first section, a system level overview is described. In the second section, embodiments of methods are described. In the third section, a hardware and the operating environment in conjunction with which embodiments can be practiced are described. In the fourth section, particular implementations are described. Finally, in the fifth section, a conclusion of the detailed description is provided.

### System Level Overview

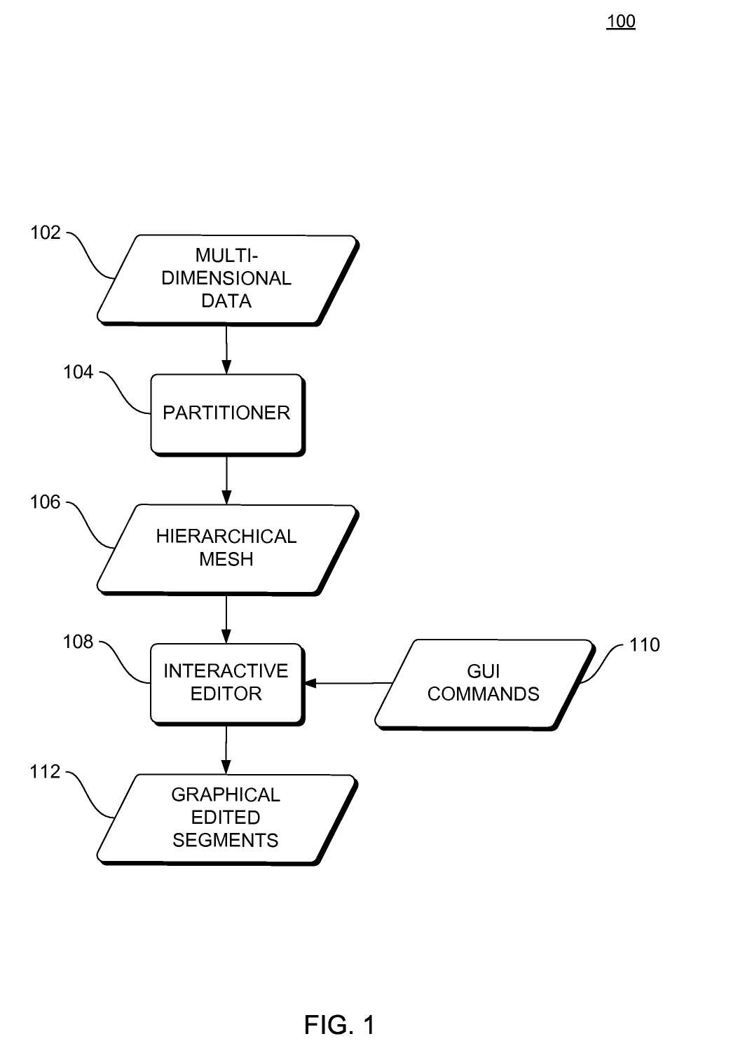

FIG. 1 is a block diagram of an overview of a system 100 to visualize healthcare diagnostic images, according to an embodiment. System 100 provides a repeatable and reproducible semi-automated image segmentation system. System 100 provides a degree of flexibility to the user in situations of imperfect or failed segmentations without having to resort to totally manual methods or methods that only provide adjustments to contours (in both two-dimension and three-dimension) and loosing the ability of repeatability.

System 100 includes multi-dimensional data 102 that is accessed by a partitioner 104. The multi-dimensional data 102 can be either two-dimensional or three-dimensional image data. The partitioner 104 partitions the multi-dimensional data 102 to form a hierarchical mesh 106. The hierarchical mesh 106 includes a plurality of segmentation elements at a plurality of scales.

System 100 also includes an interactive editor 108 that accesses the hierarchical mesh 106. The interactive editor 108 is operable to present an interactive graphical user interface (GUI) through which the interactive editor 108 is operable to receive GUI commands 110. The GUI commands 110 include, but are not limited to passively select, add, remove and divide specific segmentation elements of the hierarchical mesh 106 at any of the plurality of scales. The interactive editor 108 presents graphical edited segment results 112 of the GUI commands 110 on the interactive GUI.

System 100 provides a framework based on a hierarchical segmentation mesh for a human to interact and select relevant parts in an efficient manner to improve accuracy, precision, repeatability and reproducibility. Furthermore, the framework is extended to include several different hierarchical segmentations to permit a user to combine different segmentation algorithms to achieve his desired segmentation result.

While the system 100 is not limited to any particular multi-dimensional data 102, partitioner 104, hierarchical mesh 106, interactive editor 108, GUI commands 110 and graphical edited segment results 112, for sake of clarity, simplified multi-dimensional data 102, partitioner 104, hierarchical mesh 106, interactive editor 108, GUI commands 110 and graphical edited segment results 112 are described.

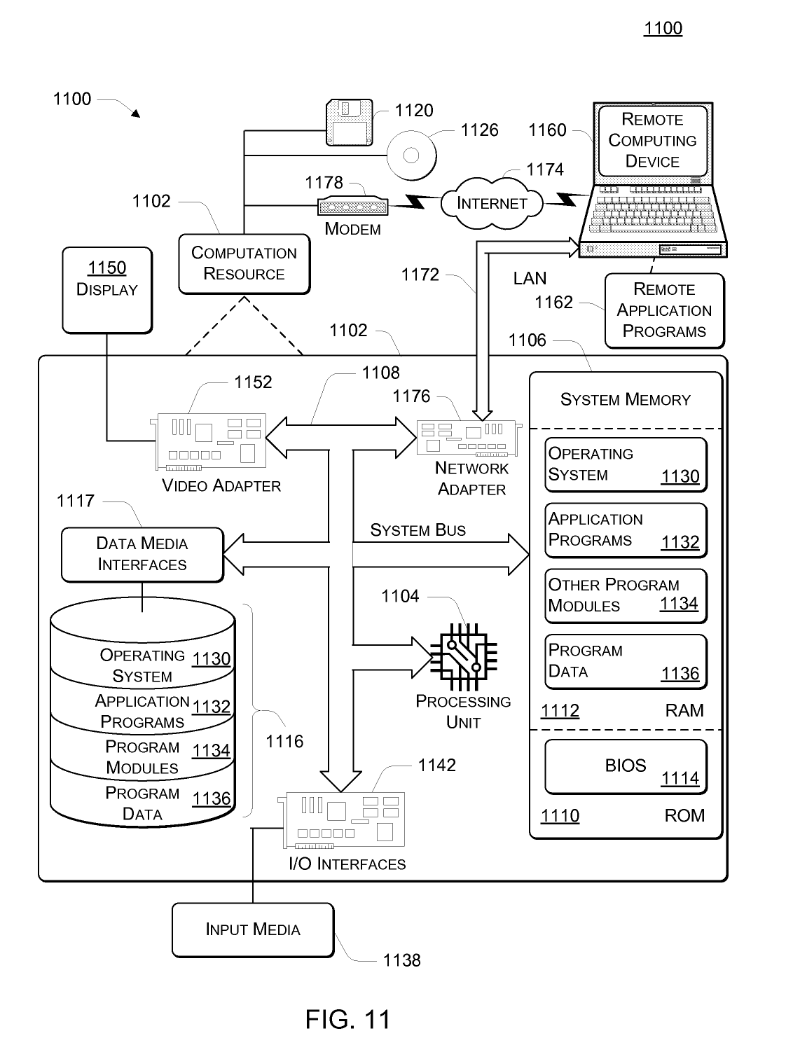

The system level overview of the operation of an embodiment is described above in this section of the detailed description. Some embodiments operate in a multi-processing, multi-threaded operating environment on a computer, such as computer 1102 in FIG. 11.

### Method Embodiments

In the previous section, a system level overview of the operation of an embodiment is described. In this section, the particular methods of such an embodiment are described by reference to a series of flowcharts. Describing the methods by reference to a flowchart enables one skilled in the art to develop such programs, firmware, or hardware, including such instructions to carry out the methods on suitable computers, executing the instructions from computer-readable media. Similarly, the methods performed by the server computer programs, firmware, or hardware are also composed of computer-executable instructions. Methods 200-500 are performed by a program executing on, or performed by firmware or hardware that is a part of, a computer, such as computer 1102 in FIG. 11.

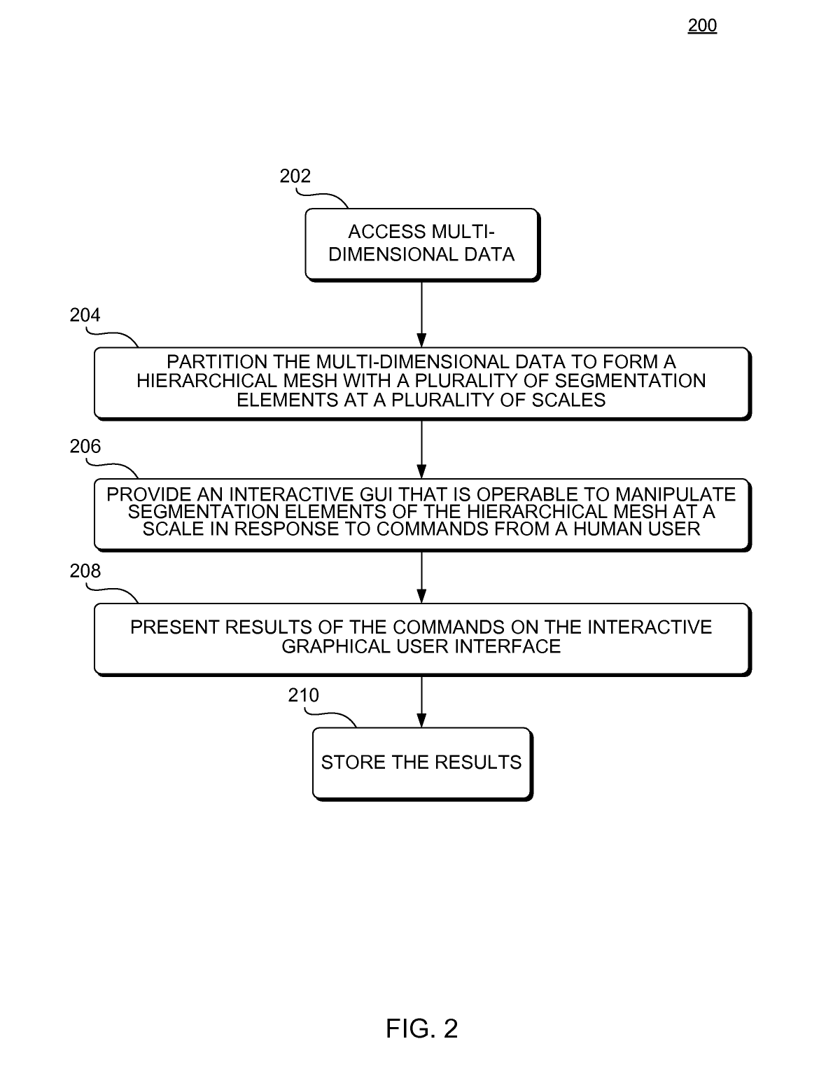

FIG. 2 is a flowchart of a method 200 visualize healthcare image, according to an embodiment. In method 300, image data to be partitioned can be either the entire data, or a partition at a specific level in the hierarchy that needs to be further partitioned. Method 200 receives two parameters, the number of threshold bins applied to the histogram, and the minimum size threshold for all connected components.

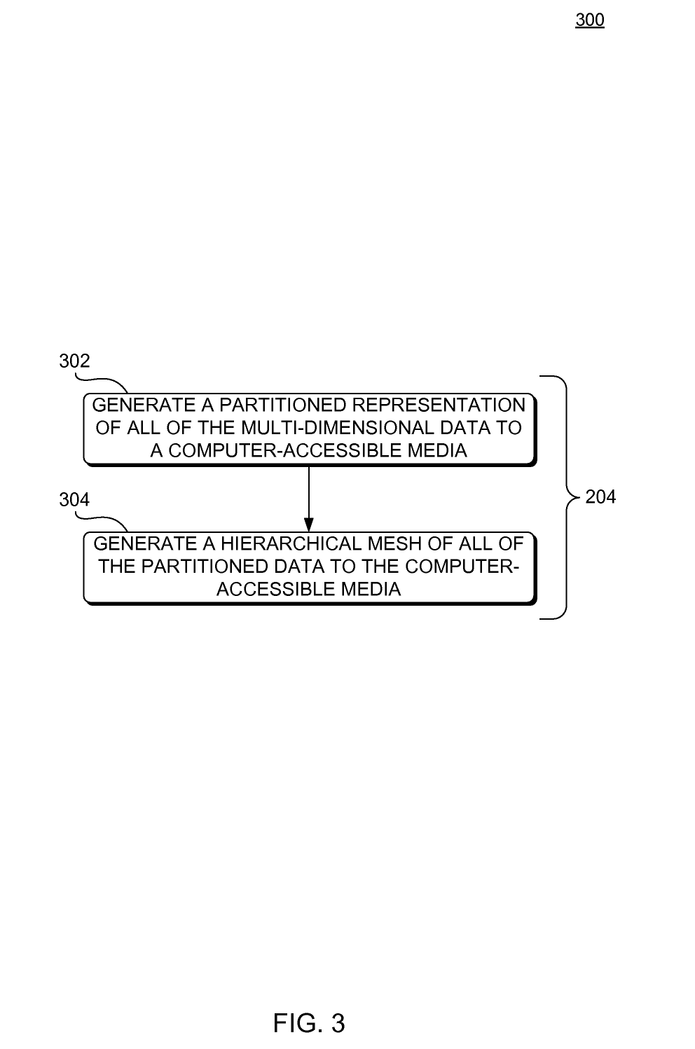

Method 200 includes accessing multi-dimensional data 102, at block 202, and partitioning the multi-dimensional data to form a hierarchical mesh 106 with a plurality of segmentation elements at a plurality of scales, at block 204. One embodiment of partitioning 204 is described in FIG. 3 below. In other embodiments of the partitioning 204, the partitioning generates an image-independent partitioned representation that is dependent on spatial location in the multi-dimensional data and is not dependent on image property/attribute (e.g. voxel intensity) of the multi-dimensional data 102. In other embodiments of the partitioning 204, the partitioning generates an image-dependent partitioned representation that is dependent on image property/attribute (e.g. voxel intensity) of the multi-dimensional data 106. In other embodiments of the partitioning 204, the partitioning generates an image-independent partitioned representation using a bottom up approach in which the segments are traversed starting at the segments that are located at the lowest position within the hierarchical mesh 106 and ending at the segment that is located at the highest position within the hierarchical mesh 106. In other embodiments of the partitioning 204, the partitioning generates an image-independent partitioned representation using a top down approach, in which the segments are traversed starting at the segment that is located at the highest position within the hierarchical mesh 106 and ending at the segments that are located at the lowest position within the hierarchical mesh 106.

Method 200 also includes providing and/or presenting an interactive graphical user interface that is operable to passively select, add, remove and divide specific segmentation elements of the hierarchical mesh at any of the plurality of scales in response to commands 110 from a human user, at block 206. Some embodiments of method 200 also include presenting results 112 of the commands 110 on the interactive graphical user interface, at block 208. Some embodiments of method 200 further include storing the results of the commands to the computer-accessible media, at block 210.

Method 200 can be implemented in two particular embodiments, as described below.

In the first embodiment of method 200, a single hierarchical mesh is derived using a single process. This embodiment refers to the hierarchical partitioning of a data set into a single hierarchical mesh, using an arbitrary segmentation process. This embodiment allows an arbitrary process to be guided by human interactions making this embodiment more robust. The user interacts with the framework as follows. The user adds and removes hierarchical mesh elements at various scales by clicking on a point in the volume. The hierarchical mesh element that contains the user's point, at the appropriate segmentation scale, is added to or removed from the current segmentation. The interaction with the mesh element is passive since no additional automated segmentation takes place during this interaction. The user has the option to select the appropriate segmentation scale with which to interact, and can use these interactions of selecting scale, and adding and removing hierarchical mesh elements to refine the segmentation in a repeatable manner. Alternatively to simplify the user interactions, given the clinical context and user's interaction patterns, the scale at which the user wishes to interact can be automatically detected. Examples of such features include considering the speed and distance the user moves the mouse, the acquisition parameters and resolution of the medical image scan, and information of the shape and size of the anatomy or pathology of interest.

In the second embodiment of method 200, a multi hierarchical mesh is derived using multiple processes. This embodiment refers to the hierarchical partitioning of a data set into several different hierarchical meshes, each using a different segmentation process. The fundamental assumption of the single hierarchical mesh approach is that the object of interest can be represented as the union of some set of hierarchical mesh elements at various scales. In practice, this may not necessarily be the case and as such, the multi hierarchical mesh framework incorporates several processes to represent the underlying object of interest. Within this multi-hierarchical mesh framework, the user can interact not only in the manner described in the single hierarchical mesh framework, but the user can also select the desired hierarchical mesh to interact with. The key concept with this passive interaction is that the user edits the segmentation result generated from interactions with other hierarchical meshes, using the currently selected hierarchical mesh. Here, the hierarchical mesh elements selected for addition can intersect the segmentation result, and those selected for removal from may have portions that are not included in the segmentation result. A significant difference of this framework is that the additional action is a union set operation between the selected hierarchical mesh element and the current segmentation, and the removal step is the removal of the intersection set operation between the selected hierarchical mesh element and the current segmentation. A use case here is that this framework would enable the segmentation of anatomy and pathology of interest using multiple processes to segment the data in a repeatable manner.

In both embodiments of method 200, an important concept is that a process or group of processes is used to generate a hierarchical mesh or set of hierarchical meshes. Once the hierarchical mesh is generated, the user can then interact with the data and select, add and remove individual mesh elements. Users can interact with the mesh elements at different levels in the hierarchy by manually selecting the desired scale, or through some automated method that selects the scale based on some pre-defined criteria. Additionally, the user may also select mesh elements from different meshes by selecting the mesh type. In this case, the user can interact with a new mesh while utilizing the result from a previous mesh. Once the user is satisfied with the segmentation, the final step involves displaying, storing or analyzing the results of the segmentation.

FIG. 3 is a flowchart of a method 300 to partition multi-dimensional data to form a hierarchical mesh, according to an embodiment. Method 300 is one embodiment of partitioning the multi-dimensional data to form a hierarchical mesh 204 in FIG. 2 above.

Method 300 includes generating a partitioned representation of all of the multi-dimensional data 102 to a computer-accessible media, at block 302. A partition is a group of non-intersecting subsets whose union may or may not be the complete data set.

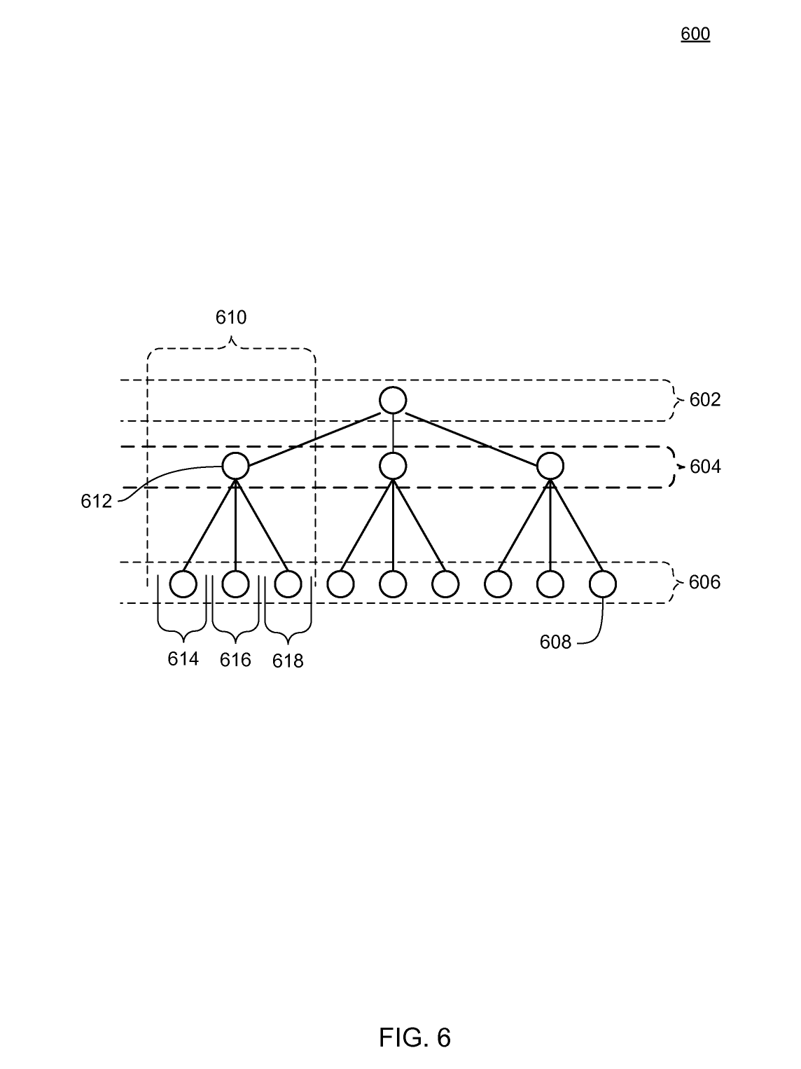

Method 300 also includes generating a hierarchical mesh 106 of all of the partitioned data to the computer-accessible media, at block 304. A mesh is some partitioning of the underlying data. The hierarchic aspect of the mesh arises from the fact that each mesh element in a partitioning can itself be partitioned, resulting in a partitioning tree, as shown in FIG. 6 below. The mesh-partitioning tree can be hidden from the user to drive the image segmentation. Note that each mesh element is simply a segmentation of the underlying volume, and can be stored very efficiently in the form of a run-length encoded (RLE) binary mask, and thus the mesh partitioning tree can be stored and manipulated using a tree of RLE binary masks.

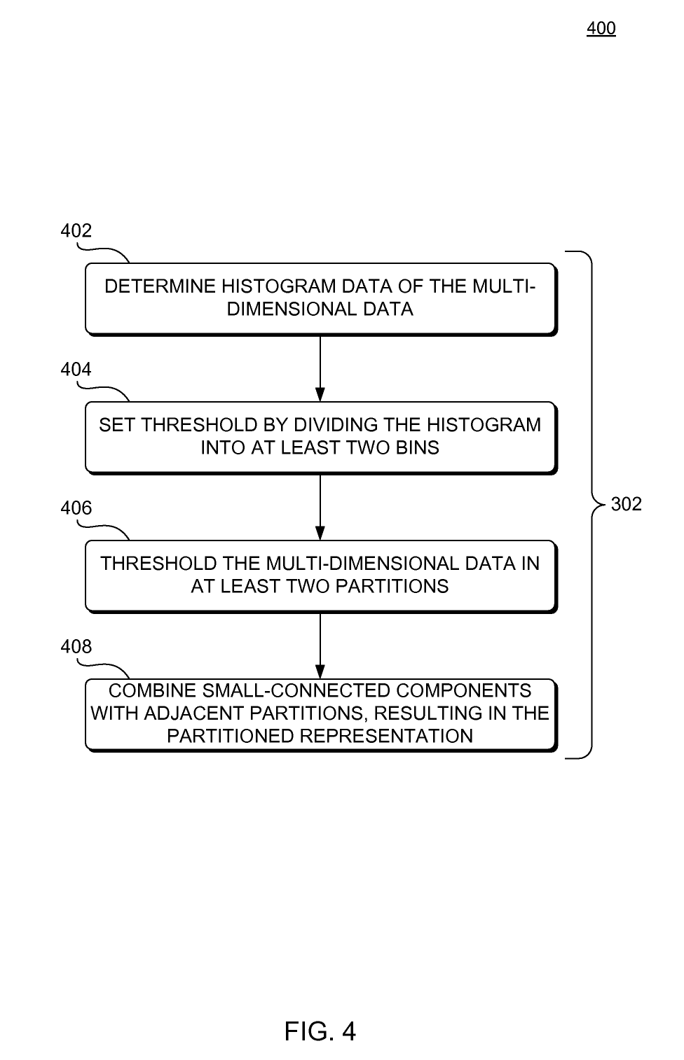

FIG. 4 is a flowchart of a method 400 to generate a partitioned representation of all of the multi-dimensional data, according to an embodiment. Method 400 is one embodiment of generating a partitioned representation of all of the multi-dimensional data 302 in FIG. 3 above.

Method 400 includes determining histogram data of the multi-dimensional data, at block 402. Method 400 also includes setting a threshold by dividing the histogram into at least two bins, at block 404. In some embodiments, block 404 further includes setting the threshold such that an area under the histogram curve in all of the bins are equal to each other. Method 400 also includes thresholding the multi-dimensional data in at least two partitions, at block 406 and combining small-connected components with adjacent partitions, resulting in the partitioned, at block 408.

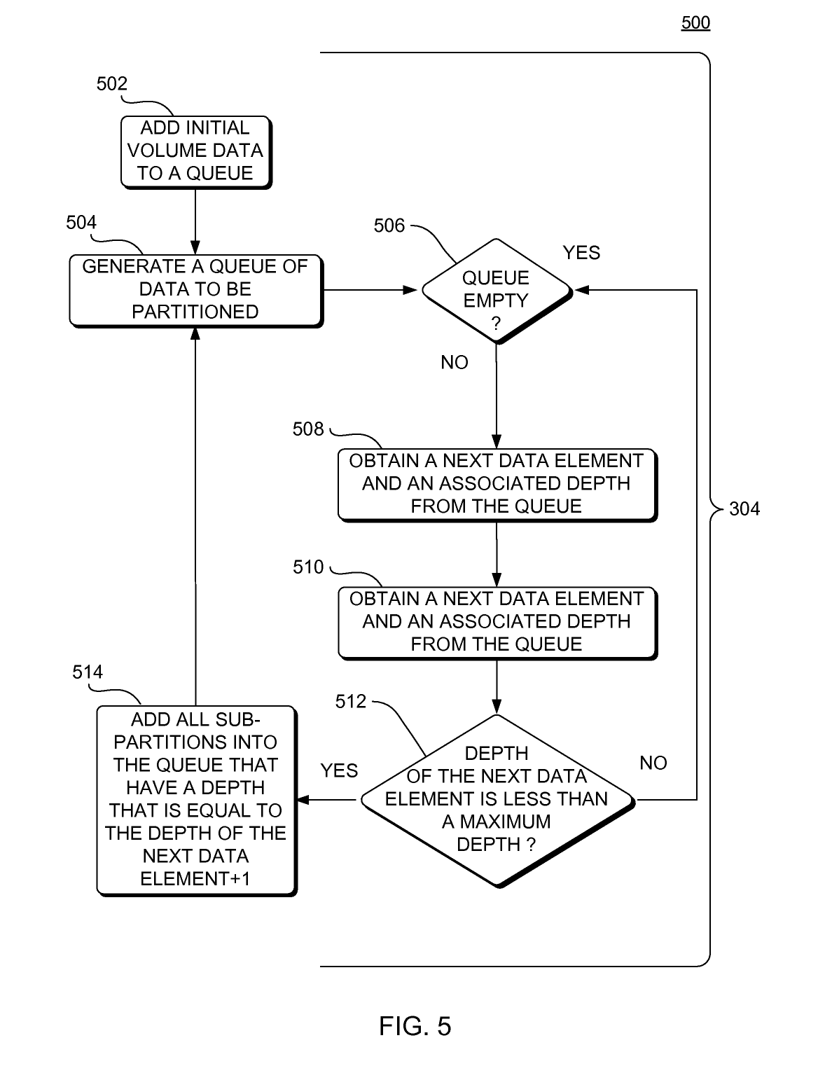

FIG. 5 is a flowchart of a method 500 to generate a hierarchical mesh of all of the partitioned data, according to an embodiment. Method 500 is one embodiment of generating a hierarchical mesh 106 of all of the partitioned data 304 in FIG. 3 above. In method 500, a maximum depth parameter that controls the depth of the hierarchy tree.

Method 500 includes adding initial volume data to a queue, having a depth of no levels, at block 502, and generating a queue of data to be partitioned, at block 504.

Method 500 includes determining whether or not the queue is not empty, at block 506. If the queue is not empty, a next data element and an associated depth from is obtained from the queue, at block 508, the next data element is partitioned into at least two sub-partitions, at block 510. Then, whether or not a depth of the next data element is less than a maximum depth is determined, at block 512. If the depth of the next data element is not less than a maximum depth, then method 500 continues at block 506.

If the depth of the next data element is less than a maximum depth, then method 500 continues by adding all sub-partitions into the queue that have a depth that is equal to the depth of the next data element plus 1, at block 514, and by incrementing the next data element to the data element immediately beyond the next data element, at which point, the method continues at block 504.

In some embodiments, methods 200-500 are implemented as a computer data signal embodied in a carrier wave, that represents a sequence of instructions which, when executed by a processor, such as processor 1104 in FIG. 11, cause the processor to perform the respective method. In other embodiments, methods 200-500 are implemented as a computer-accessible medium having executable instructions capable of directing a processor, such as processor 1104 in FIG. 11, to perform the respective method. In varying embodiments, the medium is a magnetic medium, an electronic medium, or an optical medium.

### Apparatus and Implementations

Referring to FIGS. 6-10, particular apparatus and implementations are described in conjunction with the system overview in FIG. 1 and the methods described in conjunction with FIGS. 2-5.

FIG. 6 is a diagram of a hierarchy of 600 of segmentation elements, according to an embodiment. Hierarchy 600 includes a plurality of hierarchy of levels (602, 604 and 606) of non-intersecting subsets of linked nodes (e.g. 608). In the embodiment shown in FIG. 6, the number of levels is three. In some embodiments not shown in FIG. 6, the number of levels is four.

In FIG. 6, a data set is partitioned into several non-intersecting sub-sets (e.g. 610), each represented by a single node (e.g. 612). Each partition (e.g. 610) can then be further partitioned into its own set of non-intersecting sub-partitions (e.g. 614, 616 and 618). The overall segmentation is given by selecting a group of these partition sets. If a node is selected, all its children are also selected due to the hierarchical nature of the representation.

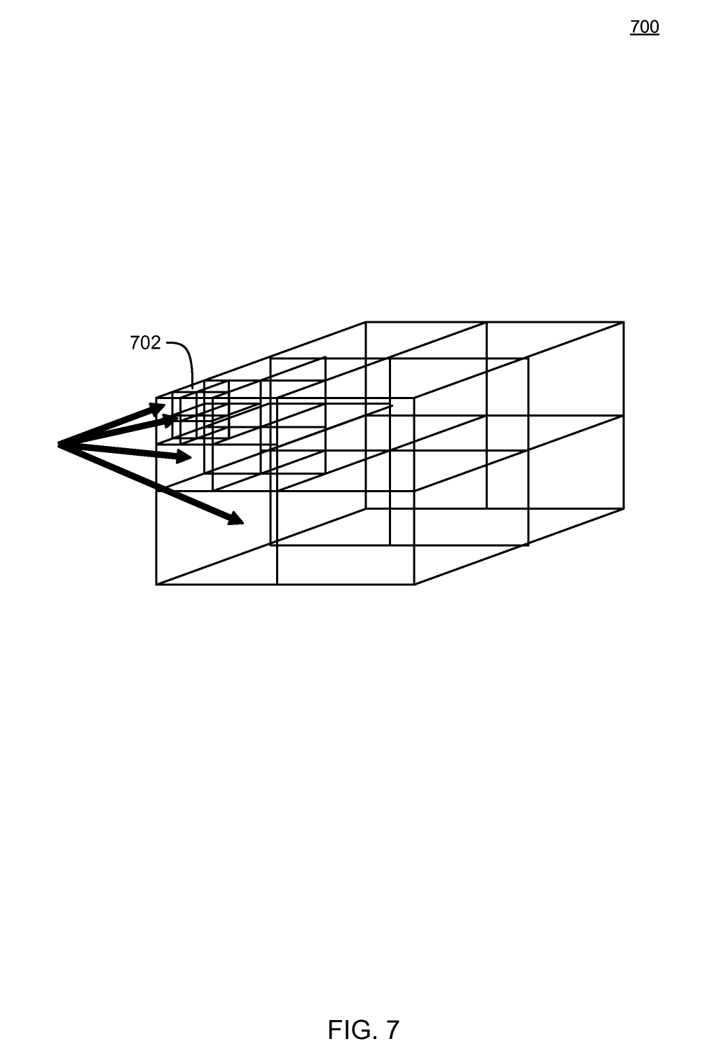

FIG. 7 is a schematic diagram of a hierarchical segmentation of a cube 700 using a basic partitioning approach, according to an embodiment. FIG. 4 demonstrates how a user can edit volumetric segmentations in a repeatable and reproducible manner.

In cube 700, user interaction in GUI commands (110 in FIG. 1) selects a set of mesh elements to compose the segmentation. The user can click on a voxel 702 using a mouse in each of the regions to select the whole segmented region. Note that to select smaller blocks, the user must select an appropriate interactivity scale. The results of partitioning that is shown in FIG. 7 is enabled by a size constrained intensity based approach. Any process that partitions the underlying data in a hierarchical fashion can be used.

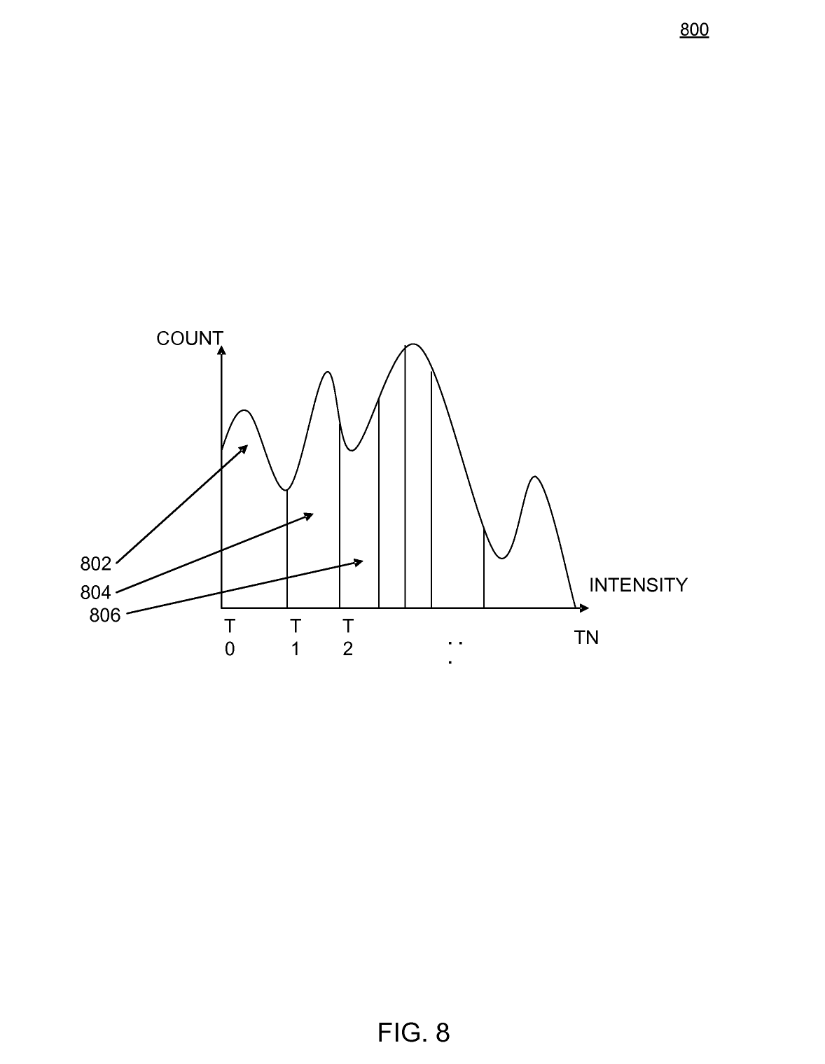

FIG. 8 is a diagram of threshold bins 800 to partition the data based on intensity, according to an embodiment. In some embodiments, the thresholds are set in block 402 in FIG. 4 as an initial action in partitioning data into a set of partitions. Once the thresholds are applied, the size constraint is applied to complete the method. In some embodiments, the thresholds are set such that the area under the histogram curve in all of the bins (e.g. 802, 804 and 806) is equal to each other.

The process shown in FIG. 8 uses the histogram of the underlying data, and sets N threshold pair values, such that the number of voxels in each threshold bin is approximately the same. Note that the value of N may vary depending on various conditions, such as the depth in the hierarchy. Once the threshold pairs are set, the data is successively thresholded using these upper and lower intensity limits. Thus, this generates a set of mutually exclusive partitions on the underlying data. Once these partition volumes are created, the size constraint is then applied. The size constraint takes a minimum size value, and ensures that all connected components in each partition are larger than that minimum size. Each connected component that is smaller than the minimum size is combined with an adjacent partition such that the union of the two components is greater than the minimum size threshold.

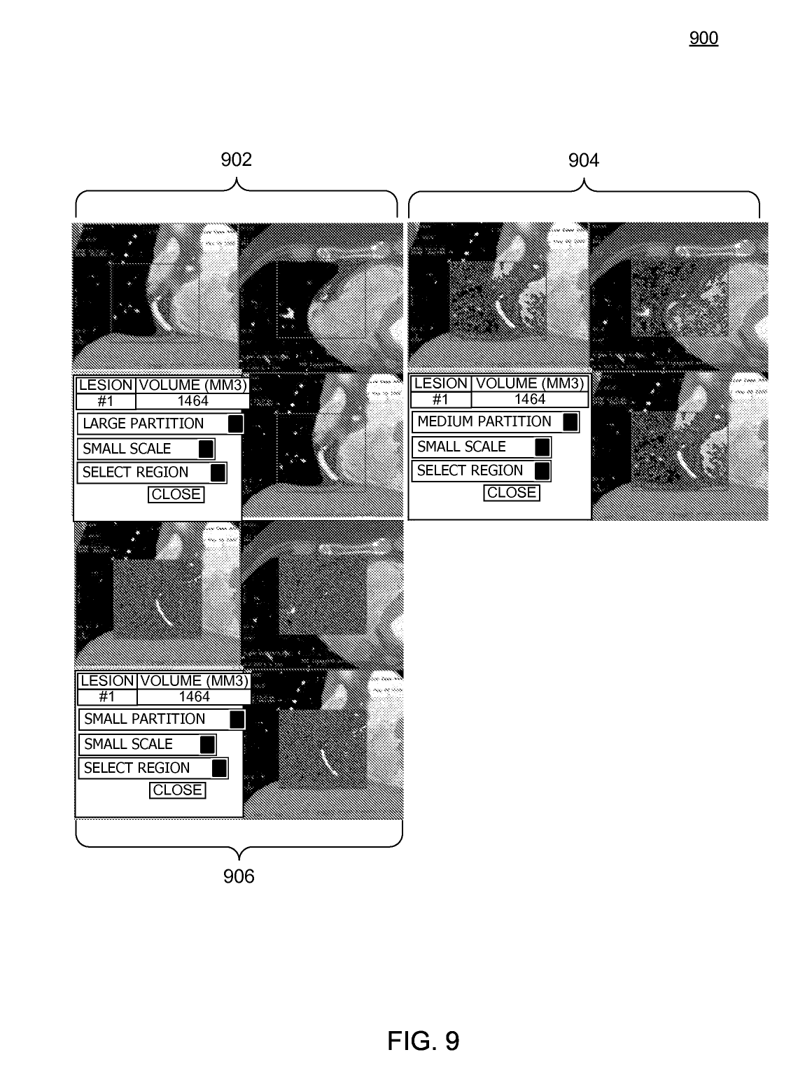

FIG. 9 is an illustration of a multi-scale three-dimensional partitioned cubed region in a CT volume, according to an embodiment. Display 902 depicts the highest level in the hierarchy. Each partition element in this mesh is further partitioned as depicted in display 904. These mesh elements are then further refined in display 906.

Apparatus components can be embodied as computer hardware circuitry or as a computer-readable program, or a combination of both. In another embodiment, systems method and apparatus disclosed herein are implemented in an application service provider (ASP) system.

More specifically, in the computer-readable program embodiment, the programs can be structured in an object-orientation using an object-oriented language such as Java, Smalltalk or C++, and the programs can be structured in a procedural-orientation using a procedural language such as COBOL or C. The software components communicate in any of a number of means that are well-known to those skilled in the art, such as application program interfaces (API) or interprocess communication techniques such as remote procedure call (RPC), common object request broker architecture (CORBA), Component Object Model (COM), Distributed Component Object Model (DCOM), Distributed System Object Model (DSOM) and Remote Method Invocation (RMI). The components execute on as few as one computer as in computer 1102 in FIG. 11, or on at least as many computers as there are components.

### Hardware and Operating Environment

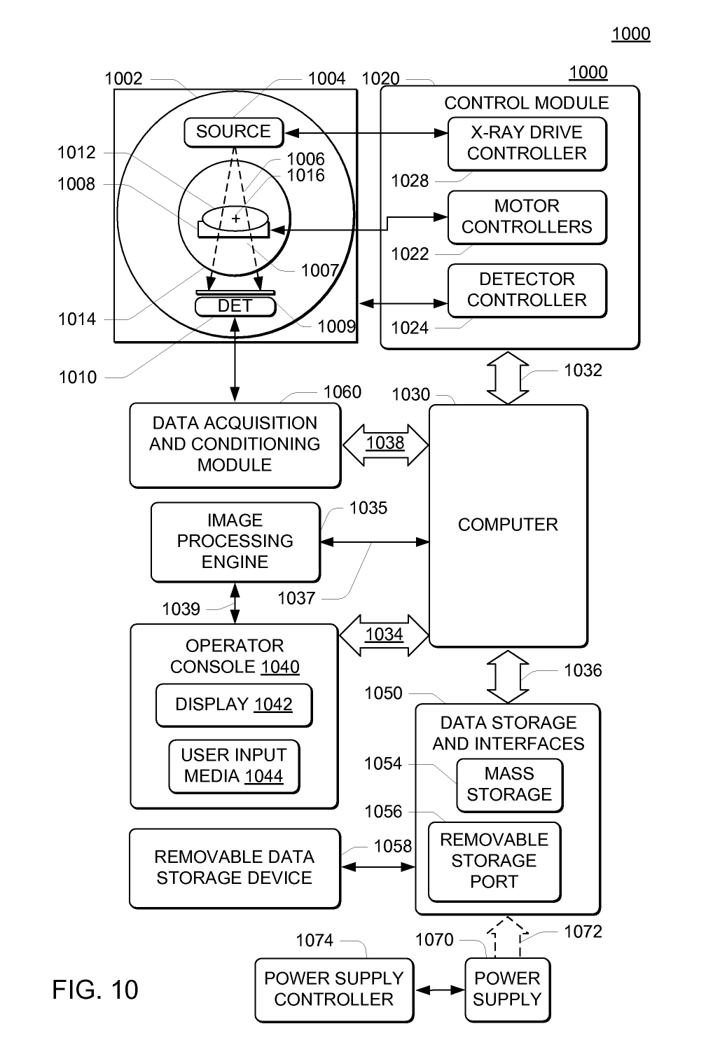

FIG. 10 is a simplified diagram of an overview of a modified system 1000 configured to improve X-ray imaging operations. The system 1000 optionally includes a gantry 1002 or other support for an illumination source 1004, such as an X-ray illumination source, capable of providing illumination 1006, such as X-rays or other non-destructive internal imaging illumination, and can optionally include a test subject support 1008 that is transmissive with respect to the illumination 1006 and that is positioned above a scintillator 1009 and detector 1010 that is also opposed to the illumination source 1004. Alternatively, a direct conversion detector 1010 can be employed without need for a scintillator.

In FIG. 10, underlying data is a three-dimensional region of interest in a computed-tomography (CT) scan. The underlying three-dimensional data is segmented into regions, which each represents a mesh element, and the segmentation process used is a simple intensity thresholding approach. Note the hierarchical representation of the segmentation, in which each region is further partitioned into sub-segments.

In one embodiment, components of the system 1000 and a test subject 1012 are maintained in a defined geometric relationship to one another by the gantry 1002. A distance between the illumination source 1004 and the detector 1010 can be varied, depending on the type of examination sought, and the angle of the illumination 1006 respective to the test subject 1012 can be adjusted with respect to the body to be imaged responsive to the nature of imaging desired.

In one embodiment, the test subject support 1008 is configured to support and/or cause controlled motion of the test subject 1012, such as a living human or animal patient, or other test subject 1012 suitable for non-destructive imaging, above the scintillator 1009/detector 1010 so that illumination 1007 is incident thereon after passing through the test subject 1012. In turn, information from the detector array 1010 describes internal aspects of the test subject 1012.

The scintillator 1009 can be a conventional CsI scintillator 1009, optically coupled to an array of photodiodes (not illustrated), such as a two-dimensional array of photodiodes and suitable control transistors formed using semiconductor material such as amorphous silicon, or any other form of detector 1010 suitable for use with the type or types of illumination 1006 being employed, such as X-rays. The detector elements are typically tesselated in a mosaic. The scintillator 1009 converts incident photons comprising electromagnetic radiation, such as X-rays, from high-energy, high-frequency photons 1007, into lower-energy, lower-frequency photons corresponding to spectral sensitivity of the detector elements, in a fashion somewhat analogous to fluorescence, as is commonly known in the context of many visible-light sources in use today. Alternatively, the detector 1010 can be formed as a flat-panel array including amorphous Silicon (α-Si) active elements, together with either a scintillator layer 1009, or a direct converter material such as Cadmium Zinc Telluride (CdZnTe), Mercuric Iodide (Hgl₂), Lead Iodide (Pbl₂), or amorphous Selenium (α-Se).

In some modes of operation, such as CT, the gantry 1002 and test subject support or table 1008 cooperatively engage to move the test subject 1012 longitudinally within an opening 1014, that is, along an axis 1016 extending into and out of the plane of FIG. 10. In some modes of operation, the gantry 1002 rotates the X-ray source 1004 and detector 1010 about the axis 1016, while the support 1008 moves longitudinally, to provide a helical series of scans of the test subject 1012, where a pitch of the helices is defined as a ratio of a longitudinal distance traveled by the table 1008 during a complete revolution of the gantry 1002, compared to a length of the detector 1010 along the axis 1016 of linear motion.

The system 1000 also optionally includes a control module or controller 1020. The controller 1020 can include a motor control module 1022 configured to move the test subject support 1008 and thus the test subject 1012 relative to the X-ray source 1004 and/or detector 1010, and can also control motors in the gantry 1002 or to position the X-ray illumination source 1004 relative to the test subject 1012 and/or the detector 1010.

The controller 1020 includes a detector controller 1024 configured to control elements within the detector 1010 and to facilitate data transfer therefrom. The controller 1020 also includes a drive parameter controller 1028 configured to control electrical drive parameters delivered to the X-ray source 1004. One or more computers 1030 provide connections to the controller 1020 via a bus 1032 configured for receiving data descriptive of operating conditions and configurations and for supplying appropriate control signals. Buses 1034, 1037 and 1039 act to transfer data and control signals, for example with respect to a module 1035, configured as an image processing engine, via interconnections such as 1037, 1039 that are configured for exchange of signals and data to and/or from the computer 1030 as well as other elements of the system 1000 and/or external computation or communications resources (not illustrated in FIG. 10).

The system 1000 also includes a bus 1036, a bus 1038 and an operator console 1040. The operator console 1040 is coupled to the system 1000 through the bus 1034. The operator console 1040 includes one or more displays 1042 and a user input interface 1044. The user input interface 1044 can include a touchscreen, keyboard, a mouse or other tactile input device, capability for voice commands and/or other input devices. The one or more displays 1042 provide video, symbolic and/or audio information relative to operation of system 1000, user-selectable options and images descriptive of the test subject 1012, and can display a graphical user interface for facilitating user selection among various modes of operation and other system settings.

The image processing engine 1035 facilitates automation of accurate measurement and assessment. The image processing engine 1035 is capable of forming multiple, coordinated images for display, for example via the monitor 1042, to provide the types of depictions described below. The image processing engine 1035 can comprise a separate and distinct module, which can include application-specific integrated circuitry, or can comprise one or more processors coupled with suitable computer-readable program modules, or can comprise a portion of the computer 1030 or other computation device.

The system 1000 also includes memory devices 1050, coupled via the bus 1036 to the computer 1030 through suitable interfaces. Datasets representing three-dimensional data and image or two-dimensional data typically conform to the digital imaging and communications in medicine (DICOM) standard, which is widely adopted for handling, storing, printing, and transmitting information in medical imaging. The DICOM standard includes a file format definition and a network communications protocol. The communication protocol is an application protocol that uses TCP/IP to communicate between systems. DICOM files can be stored in memory devices 1050 and retrieved therefrom, and can be exchanged between two entities that are capable of receiving image and patient data in DICOM format.

The memory devices 1050 include mass data storage capabilities 1054 and one or more removable data storage device ports 1056. The one or more removable data storage device ports 1056 are adapted to detachably couple to portable data memories 1058, which can include optical, magnetic and/or semiconductor memories and can have read and/or write capabilities, and which can be volatile or non-volatile devices or can include a combination of the preceding capabilities.

The system 1000 further includes a data acquisition and conditioning module 1060 that has data inputs coupled to the detector 1010 and that is coupled by the bus 1038 to the one or more computers 1030. The data acquisition and conditioning module 1060 includes analog to digital conversion circuitry for capturing analog data from the detector 1010 and then converting those data from the detector 1010 into digital form, to be supplied to the one or more computers 1030 for ultimate display via one or more of the displays 1042 and for potential storage in the mass storage device 1054 and/or data exchange with remote facilities (not shown in FIG. 10). The acquired image data can be conditioned in either the data acquisition and conditioning module 1060 or the one or more computers 1030 or both.

The system 1000 also includes a power supply 1070, coupled via interconnections represented as a power supply bus 1072, shown in dashed outline, to other system elements, and a power supply controller 1074. In some embodiments, the system 1000 is configured to be a mobile system equipped with a portable power supply 1070, such as a battery. In other words, the system 1000 can comprise a wheeled unit and can be electromotively powered in self-contained fashion, lending physical agility to the ensemble of attributes offered by the system 1000.

Volumetric data collected via exposure of the test subject 1012 to suitable illumination 1006 can be processed via many different types of tools, each intended to enhance some portion of information content described by the data. One result can be inconsistency between analytical results from different types of signal processing tools, or between measurement results corresponding to different measurement times and/or measurement phases.

FIG. 11 is a block diagram of a hardware and operating environment 1100 in which different embodiments can be practiced. FIG. 11 is a block diagram of a hardware and operating environment 1100 useful in the context of the environment of FIG. 10, in accordance with an embodiment of the disclosed subject matter.

The description of FIG. 11 provides an overview of computer hardware and a suitable computing environment in conjunction with which some embodiments can be implemented. Embodiments are described in terms of a computer executing computer-executable instructions. However, some embodiments can be implemented entirely in computer hardware in which the computer-executable instructions are implemented in read-only memory. Some embodiments can also be implemented in client/server computing environments where remote devices that perform tasks are linked through a communications network. Program modules can be located in both local and remote memory storage devices in a distributed computing environment.

The description of FIG. 11 provides an overview of computer hardware and a suitable computing environment in conjunction with which some embodiments can be implemented. Embodiments are described in terms of a computer executing computer-executable instructions. However, some embodiments can be implemented entirely in computer hardware in which the computer-executable instructions are implemented in read-only memory. Some embodiments can also be implemented in client/server computing environments where remote devices that perform tasks are linked through a communications network. Program modules can be located in both local and remote memory storage devices in a distributed computing environment.

The general computer environment 1100 includes a computation resource 1102 capable of implementing the processes described herein. Other devices can alternatively used that include more components, or fewer components, than those illustrated in FIG. 11.

The illustrated operating environment 1100 is only one example of a suitable operating environment, and the example described with reference to FIG. 11 is not intended to suggest any limitation as to the scope of use or functionality of the embodiments of this disclosure. Other well-known computing systems, environments, and/or configurations can be suitable for implementation and/or application of the subject matter disclosed herein.

The computation resource 1102 includes one or more processors or processing units 1104, a system memory 1106, and a bus 1108 that couples various system components including the system memory 1106 to processor(s) 1104 and other elements in the environment 1100. The bus 1108 represents one or more of any of several types of bus structures, including a memory bus or memory controller, a peripheral bus, an accelerated graphics port and a processor or local bus using any of a variety of bus architectures, and can be compatible with SCSI (small computer system interconnect), or other conventional bus architectures and protocols.

The system memory 1106 includes nonvolatile read-only memory (ROM) 1110 and random access memory (RAM) 1112, which can or can not include volatile memory elements. A basic input/output system (BIOS) 1114, containing the elementary routines that help to transfer information between elements within computation resource 1102 and with external items, typically invoked into operating memory during start-up, is stored in ROM 1110.

The computation resource 1102 further can include a non-volatile read/write memory 1116, represented in FIG. 11 as a hard disk drive, coupled to bus 1108 via a data media interface 1117 (e.g., a SCSI, ATA, or other type of interface); a magnetic disk drive (not shown) for reading from, and/or writing to, a removable magnetic disk 1120 and an optical disk drive (not shown) for reading from, and/or writing to, a removable optical disk 1126 such as a CD, DVD, or other optical media.

The non-volatile read/write memory 1116 and associated computer-readable media provide nonvolatile storage of computer-readable instructions, data structures, program modules and other data for the computation resource 1102. Although the exemplary environment 1100 is described herein as employing a non-volatile read/write memory 1116, a removable magnetic disk 1120 and a removable optical disk 1126. Other types of computer-readable media which can store data that is accessible by a computer, such as magnetic cassettes, FLASH memory cards, random access memories (RAMs), read only memories (ROM), and the like, can also be used in the exemplary operating environment.

A number of program modules can be stored via the non-volatile read/write memory 1116, magnetic disk 1120, optical disk 1126, ROM 1110, or RAM 1112, including an operating system 1130, one or more application programs 1132, other program modules 1134 and program data 1136. Examples of computer operating systems conventionally employed for some types of three-dimensional and/or two-dimensional medical image data include the NUCLEUS® operating system, the LINUX® operating system, and others, for example, providing capability for supporting application programs 1132 using, for example, code modules written in the C++® computer programming language.

A user can enter commands and information into computation resource 1102 through input devices such as input media 1138 (e.g., keyboard/keypad, tactile input or pointing device, mouse, foot-operated switching apparatus, joystick, touchscreen or touchpad, microphone, antenna etc.). Such input devices 1138 are coupled to the processing unit 1104 through a conventional input/output interface 1142 that is, in turn, coupled to the system bus. A monitor 1150 or other type of display device is also coupled to the system bus 1108 via an interface, such as a video adapter 1152.

The computation resource 1102 can include capability for operating in a networked environment (as illustrated in FIG. 10, for example) using logical connections to one or more remote computers, such as a remote computer 1160. The remote computer 1160 can be a personal computer, a server, a router, a network PC, a peer device or other common network node, and typically includes many or all of the elements described above relative to the computation resource 1102. In a networked environment, program modules depicted relative to the computation resource 1102, or portions thereof, can be stored in a remote memory storage device such as can be associated with the remote computer 1160. By way of example, remote application programs 1162 reside on a memory device of the remote computer 1160. The logical connections represented in FIG. 11 can include interface capabilities, e.g., such as interface capabilities 1052 (FIG. 10) a storage area network (SAN, not illustrated in FIG. 11), local area network (LAN) 1172 and/or a wide area network (WAN) 1174, but can also include other networks.

Such networking environments are commonplace in modern computer systems, and in association with intranets and the Internet. In certain embodiments, the computation resource 1102 executes an Internet Web browser program (which can optionally be integrated into the operating system 1130), such as the “Internet Explorer®” Web browser manufactured and distributed by the Microsoft Corporation of Redmond, Wash.

When used in a LAN-coupled environment, the computation resource 1102 communicates with or through the local area network 1172 via a network interface or adapter 1176. When used in a WAN-coupled environment, the computation resource 1102 typically includes interfaces, such as a modem 1178, or other apparatus, for establishing communications with or through the WAN 1174, such as the Internet. The modem 1178, which can be internal or external, is coupled to the system bus 1108 via a serial port interface.

In a networked environment, program modules depicted relative to the computation resource 1102, or portions thereof, can be stored in remote memory apparatus. The network connections shown are exemplary, and other means of establishing a communications link between various computer systems and elements can be used.

A user of a computer can operate in a networked environment 1000 using logical connections to one or more remote computers, such as a remote computer 1160, which can be a personal computer, a server, a router, a network PC, a peer device or other common network node. Typically, a remote computer 1160 includes many or all of the elements described above relative to the computer 1100 of FIG. 11.

The computation resource 1102 typically includes at least some form of computer-readable media. Computer-readable media can be any available media that can be accessed by the computation resource 1102. By way of example, and not limitation, computer-readable media can comprise computer storage media and communication media.

Computer storage media include volatile and nonvolatile, removable and non-removable media, implemented in any method or technology for storage of information, such as computer-readable instructions, data structures, program modules or other data. The term “computer storage media” includes, but is not limited to, RAM, ROM, EEPROM, FLASH memory or other memory technology, CD, DVD, or other optical storage, magnetic cassettes, magnetic tape, magnetic disk storage or other magnetic storage devices, or any other media which can be used to store computer-intelligible information and which can be accessed by the computation resource 1102.

Communication media typically embodies computer-readable instructions, data structures, program modules or other data, represented via, and determinable from, a modulated data signal, such as a carrier wave or other transport mechanism, and includes any information delivery media. The term “modulated data signal” means a signal that has one or more of its characteristics set or changed in such a manner as to encode information in the signal in a fashion amenable to computer interpretation.

By way of example, and not limitation, communication media include wired media, such as wired network or direct-wired connections, and wireless media, such as acoustic, RF, infrared and other wireless media. The scope of the term computer-readable media includes combinations of any of the above.

The computer 1102 can function as one or more of the control segments of module 1020 (FIG. 10), the computer 1030, the operator console 1040 and/or the data acquisition and conditioning module 1060, for example, via implementation of the processes 100-500 of FIGS. 1-5, respectively, as one or more computer program modules.

### CONCLUSION

An image analyzer is described. A technical effect of the image analyzer is to partition multi-dimensional image data into a hierarchical mesh. Although specific embodiments have been illustrated and described herein, any arrangement which is calculated to achieve the same purpose may be substituted for the specific embodiments shown. This application is intended to cover any adaptations or variations. For example, although described in procedural terms, one of ordinary skill in the art will appreciate that implementations can be made in an object-oriented design environment or any other design environment that provides the required relationships.

In particular, one of skill in the art will readily appreciate that the names of the methods and apparatus are not intended to limit embodiments. Furthermore, additional methods and apparatus can be added to the components, functions can be rearranged among the components, and new components to correspond to future enhancements and physical devices used in embodiments can be introduced without departing from the scope of embodiments. One of skill in the art will readily recognize that embodiments are applicable to future communication devices, different file systems, and new data types.

The terminology used in this application is meant to include all object-oriented and healthcare imaging environments and alternate technologies which provide the same functionality as described herein.

We claim:

1. A computer-accessible medium having executable instructions to prepare data for visualization, the executable instructions capable of directing a processor to perform:
accessing multi-dimensional data;
partitioning the multi-dimensional data to form a hierarchical mesh with a plurality of segmentation elements at a plurality of scales;
providing an interactive graphical user interface that is operable to passively select, add, remove and divide specific segmentation elements of the hierarchical mesh at any of the plurality of scales in response to commands from a human user; and
presenting results of the commands on the interactive graphical user interface.

2. The computer-accessible medium of claim 1, the medium further comprising executable instructions capable of directing the processor to perform:
storing the results of the commands to the computer-accessible media.

3. The computer-accessible medium of claim 1, wherein the segmentation elements further comprise a plurality of hierarchy of levels of non-intersecting subsets of linked nodes.

4. The computer-accessible medium of claim 3, wherein the levels further comprise four levels.

5. The computer-accessible medium of claim 1, wherein the executable instructions capable of directing the processor to partition further comprise executable instructions capable of directing the processor to perform:
determining histogram data of the multi-dimensional data;
setting threshold by dividing the histogram into at least two bins;
thresholding the multi-dimensional data in at least two partitions; and
combining small-connected components with adjacent partitions, resulting in the partitioned representation.

6. The computer-accessible medium of claim 1, wherein the executable instructions capable of directing the processor to partition further comprise executable instructions capable of directing the processor to perform:
setting the threshold such that an area under the histogram curve in all of the bins are equal to each other.

7. The computer-accessible medium of claim 1, wherein the executable instructions capable of directing the processor to partition further comprise executable instructions capable of directing the processor to perform:
generating an image-independent partitioned representation that is dependent on spatial location in the multi-dimensional data and is not dependent on image property/attribute of the multi-dimensional data.

8. The computer-accessible medium of claim 1, wherein the executable instructions capable of directing the processor to partition representation further comprise executable instructions capable of directing the processor to perform:
generating an image-dependent partitioned representation that is dependent on image property/attribute of the multi-dimensional data.

9. The computer-accessible medium of claim 1, wherein the executable instructions capable of directing the processor to partition further comprise executable instructions capable of directing the processor to perform:
generating an image-independent partitioned representation using a bottom up approach.

10. The computer-accessible medium of claim 1, wherein the executable instructions capable of directing the processor to partition further comprise executable instructions capable of directing the processor to perform:
generating an image-independent partitioned representation using a top down approach.

11. The computer-accessible medium of claim 1, wherein the executable instructions capable of directing the processor to partition further comprise executable instructions capable of directing the processor to perform:
adding initial volume data to a queue, having a depth of no levels;
generating a queue of data to be partitioned;
if the queue is not empty, performing the following:
obtaining a next data element and an associated depth from the queue;
partitioning the next data element into at least two sub-partitions;
if a depth of the next data element is less than a maximum depth then adding all sub-partitions into the queue that have a depth that is equal to the depth of the next data element plus 1; and
incrementing the next data element to the data element immediately beyond the next data element.

12. A method comprising:
accessing a previously segmented multi-dimensional data and an associated segmentation mask corresponding to a first segmentation technique;
creating from multi-dimensional data a plurality of hierarchical partitioned data of segmentation elements in a computer-accessible media;
performing a graphical process to passively select, add, remove and divide specific segmentation elements in response to a command to edit the segmentation mask; and
presenting results of the command on an interactive graphical user interface.

13. The method of claim 12, wherein the partitioned representation further comprises a hierarchy of levels of non-intersecting subsets of linked nodes.

14. The method of claim 12, wherein creating a plurality of hierarchical partitioned data of segmentation elements further comprises:
determining histogram data of the multi-dimensional data;
setting threshold by dividing the histogram into at least two bins;
thresholding the multi-dimensional data in at least two partitions; and
combining small-connected components with adjacent partitions; resulting in the partitioned representation.

15. The method of claim 12, wherein creating a plurality of hierarchical partitioned data of segmentation elements further comprises:
generating an image-independent partitioned representation that is dependent on space location in the multi-dimensional data and is not dependent on image property/attribute of the multi-dimensional data.

16. The method of claim 12, wherein creating a plurality of hierarchical partitioned data of segmentation elements further comprises:
generating an image-dependent partitioned representation that is dependent on image property/attribute of the multi-dimensional data.

17. The method of claim 12, wherein creating a plurality of hierarchical partitioned data of segmentation elements further comprises:
adding initial volume data to a queue, having a depth of no levels;
generating a queue of data to be partitioned;
if the queue is not empty, performing the following:
obtaining a next data element and an associated depth from the queue;
partitioning the next data element into at least two sub-partitions;
if a depth of the next data element is less than a maximum depth then adding all sub-partitions into the queue that have a depth that is equal to the depth of the next data element plus 1; and
incrementing the next data element to the data element immediately beyond the next data element.

18. The method of claim 12, wherein the command further comprises one of:
select, add, remove and divide a portion of at a scale

19. A system comprising:
a processor;
a storage device coupled to the processor; and
software apparatus operable on the processor to:
partition multi-dimensional data in the storage device to form a hierarchical mesh with a plurality of segmentation elements at a plurality of scales;
provide an interactive graphical user interface that is operable to passively select, add, remove and divide specific segmentation elements of the hierarchical mesh at any of the plurality of scales in response to commands from a human user; and
present results of graphical commands on the hierarchical mesh on an interactive graphical user interface.

20. The system of claim 19, wherein the segmentation elements further comprise a hierarchy of levels of non-intersecting subsets of linked nodes.

21. The system of claim 19, wherein the software apparatus to partition further comprises software apparatus operable to:
determine histogram data of the multi-dimensional data;
set threshold by dividing the histogram into at least two bins;
threshold the multi-dimensional data in at least two partitions; and
combine small-connected components with adjacent partitions; resulting in the partitioned representation.

22. The system of claim 19, wherein the software apparatus to partition further comprises software apparatus operable to:
generate an image-independent partitioned representation that is dependent on space location in the multi-dimensional data and is not dependent on image property/attribute of the multi-dimensional data.

23. The system of claim 19, wherein the software apparatus to partition further comprises software apparatus operable to:
generate an image-dependent partitioned representation that is dependent on image property/attribute of the multi-dimensional data.

24. The system of claim 19, wherein the software apparatus to partition further comprises software apparatus operable to:
add initial volume data to a queue, having a depth of no levels;
generate a queue of data to be partitioned;
if the queue is not empty, performing the following:
obtain a next data element and an associated depth from the queue;
partition the next data element into at least two sub-partitions;
if a depth of the next data element is less than a maximum depth then add all sub-partitions into the queue that have a depth that is equal to the depth of the next data element plus 1; and
increment the next data element to the data element immediately beyond the next data element.
